(19) United States
(12) Patent Application Publication
(10) Pub. No.: US 2013/0167535 A1
(43) Pub. Date: Jul. 4, 2013

(54) Rotary Engine with Unidirectional Monatomic Gas Flow, Static Heat Exchangers

(71) Applicant: Ronald Edward Graf, Greensboro, NC (US)

(72) Inventor: Ronald Edward Graf, Greensboro, NC (US)

(21) Appl. No.: 13/342,773

(22) Filed: Jan. 3, 2012

(51) Int. Cl. F02C 1/04

(52) U.S. Cl. 60/682

(57) ABSTRACT

An engine/heat pump is shown. The preferred model has at least one expander, being a centrifugal pump and at least one compressor, being a centrifugal pump, the rotor for the expander and the rotor for the compressor being on the same axle. The axle and rotors and all rapidly moving parts are surrounded by the working fluid, which is a monatomic gas within a substantially stationary container not pierced by any moving part. An electric dynamo also completely surrounded by the gas rotates magnets in an aerodynamic configuration simulating a group of horseshoe magnets. The dynamo coils between the ends of the magnets are also in an aerodynamic structure but stationary. The output wires extend through the gas container wall. Heat exchangers are on the paths between compressor and expander.

### CROSS-REFERENCE TO RELATED APPLICATIONS

This is not a continuation but adds a few new ideas and shows another preferred embodiment beyond the main claims of application Ser. No. 12,291,148 now U.S. Pat. No. 8,087,247, which was a continuation in part of application Ser. No. 12/152,437, which issued as U.S. Pat. No. 7,874,175. All of the above are not legally related to the current invention but are by the same inventor and given as reference.

### FEDERALLY SPONSORED RESEARCH

Not Applicable

### JOINT RESEARCH PARTIES

Not Applicable

### REFERENCE TO A “SEQUENCE LISTING”, A TABLE, ETC.

Not Applicable

### BACKGROUND OF THE INVENTION

1. Field of the Invention

Broadly, the field is external heat engines, which can also be redesigned and used as heat pumps. Sub fields are centrifugal pumps, dynamos, bearing systems, and heavy monatomic gases. Within these categories the field is external heat engines or heat pumps comprising a centrifugal fan acting as a compressor, also described as a centrifugal pump, and also comprising a second centrifugal fan, centrifugal pump, operated backwards and acting as an expander. When I say fan I am actually talking about a compressor or an expander. The fan part may be an impellor and may launch the working fluid substantially perpendicular to the rotation axis and substantially near and parallel to a tangent to the perimeter of the compressor pump. The pressure, and therefore temperature, at the perimeter of a compressor or expander is much larger than the pressure, and therefore temperature, at the center of the rotor. The pressure ratio is enhanced by using heavy molecules in the working fluid. The temperature ratio is further enhanced, beyond what the pressure ratio would cause, by using a monatomic gas such as Argon. The field will later be enlarged to cover all types of compressors that work with a working fluid that is recycled essentially forever and the working parts of which will be surrounded by the working fluid container.

One embodiment of the invention could be looked at as two substantially centrifugal compressors connected so that the conventional input of one is connected to the conventional input of the other and the conventional output of one is connected to the conventional output of the other. Thus during operation the flow in one compressor is in the reverse of the conventional direction; whereas, the flow in the other compressor is in the conventional direction. A substantially centrifugal compressor is a compressor having a rotor or impeller. It may also contain other elements of radial compressors, such as flow expanders. There may be some axial flow involved also.

One new aspect of this invention is that the compressor rotor receives torque from the expander rotor. The torque is carried by a common axle for the rotors, but could be carried by an alternative linkage.

A second new aspect is that a compressor whether centrifugal pump or positive displacement pump receives mechanical torque from an expander, the moving parts of the compressor and expander and the mechanical connection between them all being surrounded by the working fluid and by the container surrounding and containing the working fluid.

A second and preferred embodiment of the invention would use four substantially centrifugal pumps, arranged so that the rotors of pair (A and B) an expander and a compressor could be on one axle and the rotors of pair (C and D) an expander and a compressor could be on a second axle and arranged so that the peripheral orifices of pair (A and C) an expander and a compressor could face each other and so that the peripheral orifices of pair (B and D) a compressor and an expander could face each other.

Since the working fluid would be in a very slow moving container, (maybe on a moving vehicle or on a floor) but the axles would rotate very fast, and since the axles should not extend from inside to outside the container, the power would be extracted through one or more dynamos having both magnets and output coils in the same container as the working fluid. The wires from the coils would travel through the working fluid container from being immersed in the fluid to being in the relatively slow moving surroundings of the engine. Thus the coils must be stationary with respect to the container, while the magnets rotate within the container.

A third new aspect of this invention, as just described, is that the coils are stationary and the electric power wires pierce the working fluid container. Thus the wires and their insulation are part of the container and also they carry the output power from the engine to the outside without losing any working fluid or requiring any complicated seal, as would be required if the axle pierced the container, because the axle moves relative to the container. Since the voltage would be very high, there will be a voltage transformer either inside or outside the working fluid container. Another way to get power out of the working fluid container without piercing the container with a moving part is to adapt one of the commercially available transformers having a coil moving in rotation around its winding axis but inside a second but stationary coil wound around the same axis, the two coils separated from each other by a dielectric material such as glass. The varying field of the first coil is a varying field within the second coil. The glass would be part of the fluid container. A bar of magnetic material could be inside the moving inner coil. In this case the dynamo coils away from the rotation axis and part of the dynamo could rotate while the magnets of the dynamo could be stationary. The coils of the transformer would be coiled as if they were wound around the extension of the dynamo and engine axle. Either of the above methods describes a means to transmit electric power from a dynamo inside the substantially stationary fluid container to wires outside of said substantially stationary fluid container part of said means forming part of said substantially stationary fluid container

A fourth new aspect of this invention is that the wire coils and also the magnets of the dynamo are aerodynamic for rotation, either having circular symmetry around the axle extended or being encased in a material having circular symmetry around the axle extended thus reducing drag and eddy currents in the working fluid between the coils and the magnets. Advantageously, the place where fluid motion is most different from the coils or magnets is near the axis of rotation, where pressure is least and linear motion is least.

Of course, alternately to the other preferred embodiment, all four centrifugal pumps could be on the same axle as long as the hot heat exchangers and cold heat exchangers are hooked up properly to the inputs and outputs of the centrifugal pumps. Alternately, each centrifugal pump could have its own axle; however there must be a way to transfer torque from the expanders to the compressors. The axle is probably the best way to transfer torque.

A fifth new aspect of this invention over the ones disclosed in my previous inventions is that the heat exchangers can be any size and placed just about anywhere. They do not need to rotate with the engine. However, the previous inventions were illustrated with a figure showing a cold heat exchanger located at the rotation axis and rotating with the engine. The previous inventions and the new invention each show compressors and expanders connected so that the flow of the working fluid is unidirectional, being continuous and at substantially constant speed at most, if not all, reference points, during several cycles of device operation when the device is operating substantially at constant speed in its preferred speed range said reference points being stationary with respect to the engine. The constant speed aspect may be removed from the most general claim.

2. Description of Related Art

There are many external heat engines that expand and contract a working fluid. One of my favorites is the Stirling engine which in its most famous form uses a large piston to oscillate the fluid between being cooled and being heated. The oscillation of temperature is caused by sending the fluid through a regenerator and having a heat exchanger hot source on one end and a heat exchanger cooling source on the other end of the regenerator. The power output piston communicating with the same working fluid as that being oscillated is synchronized out of phase with the oscillator piston. There is friction and pressure and temperature loss at both pistons. Also the dead volume versus piston displacement must be kept small. My invention requires no piston and no chamber that changes volume, such as a piston chamber. Also a regenerator, which causes power loss by fluid drag and thus pressure loss across the regenerator, and which also causes power loss by temperature difference hysteresis between the regenerator parts and the fluid, is not necessary in my invention because the full temperature change from hot heat exchanger to cold heat exchanger occurs in the centrifugal pumps. I may add a counter flow heat exchanger to replace part of the temperature change necessary in the pumps.

Other engines use a compressor followed by an expander, but then open to the atmosphere. The closest to my invention use axial compressors that push the fluid along the rotation axis of an impeller. A jet engine, for example, is an internal combustion engine that can use a compressor up front. The impeller moves with respect to its housing. This produces energy loss even when the engine is only idling. It may also cause problems when the blades move faster than the speed of sound with respect to the casing in which they reside. If multiple compressor blade groups are used then eddy currents and turbulence will develop wasting energy. On the other hand, in some of my designs, I put a disc on either side of the rotor blades, so that the blades do not sweep along their immediate surroundings.

My earlier invention, now patented, has almost zero losses due to motion of parts with respect to each other. The rotors are attached to the container. However, in the preferred embodiment of that patent, it rotates the whole container of the working fluid and thus is best used in solar power, where the hot heat exchanger can be fed on the fly by heat rays moving at the speed of light from the sun. My new invention, while having rotors moving with respect to their casing, can have the rotor blades protected between substantially disc-like plates, so that the blades do not move with respect to their immediate surroundings, namely the discs also called plates. The discs themselves can be away from their surroundings, except on or near their peripheries. They can also diverge as their perimeters are approached to allow the fluid gradually more cross-section to flow through. Each disc being symmetric around its axle or axle extended, causes little drag on the surrounding working fluid.

My new invention, in its preferred form has essentially no working fluid loss, because the container has no openings or moving seals. It also has little energy loss when idling, since the impellers are contained within a pair of rotating discs, so that no part sweeps past another part at other than a zero angle with respect to each other. In other words the working fluid is not scraped off a surface near the impellors, as would be the case with some current fan designs, used in, for example, a jet engine pre-compressor. Also my engine has no moving seals contacting the working fluid, thus requiring no lubrication other than bearings on an axle between rotors. While my first patent had power extracted by rotation of the central pipe, the current application shows power extracted by electrical wires coming out of the working fluid container. Both the first and the current application have no moving seals where the working gas can escape.

The most closely related art would be centrifugal compressors, since my invention combines at least two of these, but the output of the one used as expander is at the fan area closest to the axis of rotation. Thus an expansion fan is operated like a compressor in reverse, receiving input far from the axis and expelling output very near the axis. To get a larger ratio in pressure between the input and output of the compression fan, the spiral as it goes from the center to the outside should be retrograde (counter to the rotation direction). If retrograde, then the normal to the surface of a compressor blade that pushes the working fluid has a positive radial component. Similarly in the expander the normal to the blade being pushed by the working fluid is also pointing with a positive radial component.

The larger the pressure ratio, the larger the temperature ratio can be and thus the larger the theoretical efficiency of the engine. The current limit of the compression ratio on centrifugal compressors is about ten to one (10 to 1), when pushing air. External heat will be added after the compression, when the fluid is substantially furthest from the axis of rotation. For a monatomic gas the temperature ratio is 2 to 1, given a pressure ratio of between 6 and 7. The 2 to 1 ratio in absolute temperature means a theoretical efficiency of 50% converting heat to mechanical energy. That is the theoretical efficiency of a Carnot engine operating between those temperatures. My invention can achieve a much higher temperature ratio, and therefore efficiency, when argon or a mixture of krypton and helium is used. These three gases are monatomic.

The heat cycle of the preferred engine of this invention combined with the use of centrifugal pumps causing smooth unidirectional flow, is not the same as former art, with the exception of my own patent. The very high temperature ratios in the centrifugal pumps are made possible by using monatomic gas, and this high ratio makes it possible to not use a regenerator thus allowing smooth unidirectional flow. However, a counter-flow heat exchanger can receive the hot exhaust from an expander and run counter to the cooler flow leaving the compressor. The working fluid goes through adiabatic compression, followed by adding heat in the flow from a compressor periphery to an expander periphery causing some expansion, followed by adiabatic expansion in a reverse compressor (expander), followed by cooling in the flow from the center outlet close to the rotation axis of this expander to the center input close to the rotation axis of a compressor, causing some contraction thus arriving at the start temperature. This is the complete temperature cycle of the fluid. Ideally, the forced compression and expansion parts of the cycle are performed adiabatically (no heat added or subtracted from the working fluid). Actually some heat exchange with the chamber may take effect, but not much compared with all former art engines, because the temperature of the fluid is constant at any particular point in the circuit during periods of constant engine speed.

According to formulas for adiabatic compression, for a given pressure ratio the temperature ratio for a monatomic gas is greater than it is for a gas consisting of multiple atoms per molecule. The multiple atoms in a molecule supply more degrees of freedom and thus more capacity to store the heat caused by the compression. This higher temperature ratio for monatomic gases is important for engine efficiency as mentioned above.

Ideally the blades of the centrifugal fans meet the fluid so that the fluid is traveling in a direction parallel to the blade surface just before contact and just after leaving each blade. Each blade may be replaced by several blades at varying distances from the axis. Ideally, for maximum efficiency the pressure difference in each fan is maximized and possibly augmented by the effects of a counter-flow heat exchanger producing the largest temperature ratio possible. The extreme pressure ratio achievable on centrifugal compressors for air is about 10:1 in current art. At ratios above ten for air the compressor may wear out fast and may be dangerous. There is a lesser problem with a heavier gas such as Argon or Krypton. A ratio of 7:1 would be adequate for very good efficiency, reduced risk, and reduced energy loss within the engine. With Argon, that pressure ratio causes more than a 2:1 ratio in temperature, adequate to get nearly a 50% efficiency. Krypton is twice as heavy as argon and thus will produce a much higher pressure ratio and higher efficiency, but it is more scarce and costs more. Efficiency is more important in a solar collector system. The ratio of the number of mirrors necessary is equal to the ratio of efficiencies. In a solar collector system, number of mirrors is inversely proportional to efficiency to get the same energy output. Argon is about 1% of the atmosphere. Thus when oxygen 20% of atmosphere is extracted the amount of argon by-product is about 5% of the amount of oxygen.

Of course, the compressor and expander can be made similar to modern compressors in that the fluid in the compressor can be centrifuged by a central rotator and rammed into a set of stationary channels to increase pressure. The fluid would then be channeled toward and then sent into the stationary channels leading to the expander. However, this would dramatically increase flow pressure losses because of high velocity relative to the stationary parts of the compressor and expander.

In order to get power from the rotors transferred to outside the working fluid container, it is best to use a dynamo. The wire carrying the current and voltage can penetrate the container from inside to out without friction loss or fluid loss. The rotation of the rotor can be used to rotate magnets attached to a cylinder which is attached to a disc of the rotor. The magnets would be pointing inward toward the axis while the stationary wires will be attached to a stationary central stem which would be on an imaginary extension of the rotor axis. Both the magnets and the wires should be encased in material to make them aerodynamic during rotation. The magnets will be in a fluid substantially rotating with the magnets. The coils will be in a swirl of fluid set in motion by the magnets. Thus drag at the magnets is minimal. That drag is induced by the slowing of the swirl caused by the stationary coils, which drag on the swirl, but near the rotation axis where the velocities and effects are less. Also, the pressure is less near the center. The pressure near the center can be further reduced by allowing some leakage into the area from the pump disc and simultaneously preventing the higher pressure from the periphery from getting in. Instead of encasing the magnets the material of the magnets can be shaped like a tire, which would be aerodynamic. So the fields of fluid dynamics and of dynamos would apply.

The rotation of the rotors can be started either by using the dynamo as an electric motor or by attaching electric motors on the pumps not having dynamos attached. The wires would of course pierce the fluid container and one set of coils should be stationary. A commutator could be used, since the electric motor will not operate for long periods and the commutator could be disengaged at high speeds. Better than a commutator for a motor would be an optical sensor that would change the polarity of the voltage applied to the coils of the dynamo depending on the position of the magnets. The voltage applied would be controlled by electrical amplifiers, between the sensor and the dynamo coils, in obvious ways. So the fields of electronics and dynamos would apply.

Electromagnetic bearings such as are used in centrifuges can be used for the high rotation rates associated with the rotors, once they reach operational rates. The technology used for high speed trains would also apply, since the circumference of the rotors, actually of the discs holding the rotors, is moving very fast.

One object of the current invention was to produce an engine/heat pump which, when operating at a steady speed, has no changes in temperature at any particular point. Thus heat loss due to changing operating temperatures at a particular position are negligible, since the temperature of the working fluid is always the same as the temperature of its nearest container wall. This is accomplished by using the centrifugal pumps thus allowing smooth unidirectional flow both in the pumps and in the fluid connections between the pumps. Where positive displacement pumps are used in former art there are wild temperature variations at points in the pumps. Where regenerators are used there are wild temperature variations at points in the regenerators.

Heat loss due to conduction along the parts with spatial temperature differences, mainly in the compressor and expander where temperature as a function of position changes rapidly, can be minimized in several obvious ways, including putting an insulating layer on the surface contacting the working fluid. To protect the magnets from high temperature, it would be wise to remove the insulating layer near the axle, so that heat can escape from the dynamo to the rotor or cooler part of either the expander or compressor, depending on whether the dynamo is located near the compressor or the expander. The compressor would be cooler.

Another object was to produce an engine where there is essentially no loss of pressure around pistons or blades. Prior engines would produce localized circulations and turbulence especially where the blades are close to the blade casing. There is rapid relative motion between closely spaced components in most if not all prior art. In my invention the amount of casing which is near moving parts is minimized. Also moving surfaces at an angle to the container, where the intersection of the surfaces is moving, are minimized or eliminated by using discs to hold, encase, and rotate with the rotor blades.

Another object of the invention was to produce an engine that would have no loss of working fluid to the outside or around pistons, since substantially the working fluid is in a container that does not change shape or volume, except for stress or strain. There are no moving elements that pierce the skin of the container. Argon and krypton gas would not permeate or escape from its enclosure if steel is used. Only the electric wires pierce the skin of the working fluid container.

Another object of the current invention was to produce an engine which produces very little metal fatigue, since the rotating parts maintain a nearly constant rotational speed thus keeping stress almost constant. Metal fatigue in former art is caused by metal bending back and forth under varying stress.

Another object of the current invention is to produce an engine that needs no lubrication, except at the axles. There is no other friction wear in the engine.

Another object of the current invention is to produce an engine that needs no seals. The seals could produce a problem in other engines at high temperature.

Another object of the current invention was to produce a very low loss heat pump that allows the temperature ratio to be varied, by varying the rotation speed.

Another object of the current invention was to produce a heat pump that can be made mostly from aluminum and use argon as the working fluid.

Another object of the current invention is to use a rotor to eject fluid at a high pressure near the periphery, the rotor consisting of tubes having increasing cross-section as we move outward from the rotation axis. The tubes may be comprised of two consecutive blades and that portion of two discs extending between the blades. The discs, which sandwich the blades between them thus supporting the edges of the blades, may flare outward away from each other as we travel away from the rotation axis, thus looking something like parabolic mirrors. They should approach the fluid container at or near their periphery and no sudden change should be made in the flow cross-section as the fluid enters the conduit between pumps. It may be useful to have a knife edge on the periphery of the discs, so the discs can remain strong and yet approach the conduit entrance smoothly with the surface closest to the blades.

The above objects apply both to the old patent and application and to the new application. The below objects are new and apply to the new application.

Another object of the current invention is to produce an engine having the smooth uniform flow properties of the current invention and also allowing the heat exchangers to be any size and located anywhere and stationary, limited only by the pressure losses due to fluid drag within them. For example, a Stirling engine, for efficiency, should limit the size of its heat exchangers to less than the swept volume in its pistons. My previous inventions in the specification, other than the claims, were limited as to location of the cold heat exchangers and the examples showed the heat exchangers in motion. For another example, the hot heat exchangers, if tubes, can be placed in a stack, so that some parts are in the flames and others are heated by the exhaust products of combustion.

Another object of the current invention is to produce an engine where the only moving parts are the rotors, the dynamos attached to rotor discs, and the rotor axles. If one of these parts fails, the broken pieces may be contained by the fluid container, thus preventing damage to surroundings.

Another object of the invention was to produce an engine with negligible friction loss, since there are almost no solid parts moving relative to each other due to the engine cycle. Of course, as with most engines, the rotor shaft is rotating with respect to parts of the device supporting the shaft, such as bearings whether ball or magnetic. Also, the perimeters of the discs holding the rotor blades will move in a circle relative to the container of the working fluid. We have a moving circle opposing a fixed circle, the configuration looking the same at all times and thus minimizing fluid induced drag.

Another object of this invention is to produce an engine where a compressor is driven by an expander, the torque being transferred by a mechanical connection, such as an axle, fully contained within the working fluid container. Any mechanical connection, not necessarily axle could be used. Also any type of compressor or expander, such as those using rotary gears, could be used.

Another object of this invention is to drive a dynamo using torque from an expander to the dynamo and using a wire from the dynamo, piercing the fluid container to carry power from inside the engine to outside the engine.

Another object of this invention is to make the wire coils and also the magnets of the dynamo aerodynamic, either having circular symmetry around the axle extended or being encased in a material having circular symmetry around the axle extended. This would reduce drag and eddy currents in the working fluid between the coils and the magnets.

### BRIEF SUMMARY OF THE INVENTION

The invention is an external heat engine, which can be modified to serve as a heat pump. The engine comprises a heat exchanger to remove heat from a working fluid to some external heat sink, followed in the flow of the working fluid by a substantially centrifugal compressor, which, like all centrifugal compressors comprises an impeller or rotor to urge fluid in a direction with a positive radial component comparable or larger than the axial component. The compressor may be thought of as a centrifugal pump. It is followed by a heat exchanger to add heat to the working fluid from an external source. This heat exchanger is followed by an expander which is another substantially centrifugal compressor operating with flow reversed from that of a conventionally operated centrifugal compressor so it can be used to act as an expander. This expander's conventional output, near the periphery, is actually a fluid input as far as flow is concerned during sustained power production. This expander's conventional input, near the rotor axle, is actually an output as far as flow is concerned. This expander is actually built physically like a centrifugal compressor even though it is operated backwards with respect to flow direction, when the engine is producing power. To clarify, when a centrifugal pump for gases is operated conventionally, the gas is input to the pump at its conventional input near the center of rotation of the rotor and the gas is output at the conventional output, which is located near the periphery of the pump. The flow output from the expander goes to a heat exchanger to remove heat, which may or may not be the original heat exchanger to remove heat mentioned above at the start of this paragraph. The temperature ratio from input to output of the at least one compressor is bigger than the temperature ratio from the output of a compressor to the input of the next expander. This is accomplished by using a monatomic gas combined with a high pressure ratio in a compressor. The temperature ratio in the expanders may be comparable to but not necessarily the same as the inverse of the ratio in the compressors. Of course any external heat engine including the one described above can be operated as a heat pump.

In its best design, the engine consists of an axle with a rotor on each end and another axle with a rotor on each end. Each of the four rotors is part of a respective centrifugal pump. The rotor on one end of an axle is part of an expander and the rotor on the other end is part of a compressor. The center inlet of one pump on one axle is connected to the center inlet of the second pump on the same axle by a cool fluid conduit, which also contains a heat exchanger to remove heat from the flow while the fluid travels from one centrifugal pump to the other. The other two pumps, which are on the other axle are hooked up for cooling between them in the same way. The housing which holds the working fluid surrounds the four rotors and the axles, among other parts. It is shaped so as to complete the centrifugal pumps. It is also shaped to contain, except for part of the cooling fluid path, the heat exchangers on the cool fluid conduits traveling along the axles. The cooling fluid enters and travels separately with respect to the working fluid along those conduits in a reverse direction to the flow of working fluid in those conduits. The rotor blades for each rotor are sandwiched between a respective pair of discs to which they are attached. Do not take the word discs too literally. They will probably be thinner, knife edged, at the perimeter and thicker near the center of rotation. They may also diverge from each other as their perimeters are approached. This divergence helps to slow the acceleration of the working fluid and increase the pressure change. The fluid pressure change rather than flow rate is emphasized at the output from the compressor. The discs also prevent the blades from sweeping working fluid from their surrounding surfaces. Each blade may be replaced by multiple blades at varying distances from the rotation axis. A set of blades may be rotatable to a small extent relative to the discs holding them in place. Rotated blades could allow the engine to compensate for the effects of differing speeds by adjusting blade angle so that the fluid always meets each blade substantially parallel to the blade surface.

Attached to at least one outer disc for a compressor or for an expander is an array of magnets or the holder of the array. This is part of a dynamo to extract electric power from the engine. The output voltage coils of the dynamos are attached to wires which penetrate the housing which holds the working fluid. The discs holding the blades and also the blades are thermally insulated on their surfaces to minimize heat loss, except near the axle where it is desired to have heat flow through a disc from inner to outer surface to cool the dynamo volume containing the magnets.

The fluid output from the periphery of each of the two centrifugal pumps being used as compressors is connected by a hot fluid conduit to the input at the periphery of a respective one of the two centrifugal pumps being used as expanders. The two hot fluid conduits each has a means to add heat to the working fluid as it passes through them. This means may be a second fluid conduit which enters the hot fluid conduit, or the heating may be applied directly to the hot fluid conduits, each of which may comprise multiple tubes. Of course, each cool fluid conduit could also comprise multiple tubes.

The hook-ups for the two expanders and two compressors have just now been described above. The axles holding the rotors would probably be mutually parallel. The hot fluid conduits need not be straight. Thus the axles may be close together without limiting the length of the conduits, if each hot fluid conduit travels from one axle to the other. If the conduits are straight, then the rotor configuration looks a lot like the four wheels of a car. If the rotations are in the same direction, then one hot fluid conduit would be above on one side of the car and the other conduit would be below on the other side. If the axles rotate in the opposite directions, then the fluid in one hot fluid conduit would travel from above to below and the fluid in the other hot fluid conduit would travel from above to below also. In other words for the hot heat exchanger entrance and exit, there is always a switch from above to below or vice-versa when going from one axle to the other if the one axle rotation is in the opposite direction from the other.

A second version of the engine could contain only one axle and two pumps. It would have one cold heat exchanger conducting working fluid along the axle between the central openings of the two centrifugal pumps. The hot heat exchanger would conduct working fluid from the peripheral output of the compressor to the peripheral input of the expander. The hot conduit could of course be shaped like a “U”, the two ends of which are substantially along a line through the center of the axle. It could consist of a group of tubes to which heat is applied from some external source. The cold fluid conduit could of course also consist of a group of tubes. The dynamo magnets or magnet holders would be attached to one rotor and a starter electric motor might be attached to the other rotor if the dynamo is not used as a starter. Instead of using a separate electric starter motor, it would be relatively easy to feed electricity to the coils in sync with the coil positioning relative to the magnets by using an optical sensor and electronic amplifier circuits.

The power output of the engine is the net difference between the power input to the compressor and the power output from the expander. Since the fluid is further heated and thus expanded after compression, it is traveling at a higher volume flow rate into the expander than it was flowing leaving the compressor. This allows it to do more work in the expander than was used in the compressor. The temperature change while traveling from compressor to expander or the other way can be enhanced by using a counter-flow heat exchanger. Principals of compressor design including expansion of fluid path cross-section to increase pressure difference at the expense of speed apply somewhat. The fluid pressure change rather than flow rate is emphasized at the output from the compressor.

Of course the pressure difference from input to output of the compressors must exceed the pressure difference from input to output of the expanders for the engine to balance, since we are dealing with a closed loop, and since some pressure losses will occur in the heat exchangers. Therefore, it is best to have a more pronounced spiral in the compressors than in the expanders.

The spirals mean that the engine should not suddenly stop, but should slow gradually. Otherwise the working fluid may begin to flow backwards. This effect can be handled in many ways, such as loosely coupling the engine to the load.

To optimize engine performance assuming that during optimum performance speeds the temperature along the hottest heat exchanger does not reduce much, say a hundred degrees, do the following. Put a second engine of similar design down-stream from the heat source. This would allow the unused upper temperature heat discarded by the first engine of this invention to be used by a second engine of this invention. There may be a series of engines until the upper temperature discharge of the last stage engine approaches 3/2 of the lower temperature discharge of the last stage engine. At this point further efficiencies would approach 30% and might not justify the cost of another engine stage. The two axle design can be operated as a two stage engine or as two parallel single stage engines. Of course there are other uses for the exhaust heat, including heating the input air or fuel for higher temperature combustion. Stirling engines or any external heat engine has the same problem.

The temperature differences can be enhanced by using a counter-flow heat exchanger. It would take heat from a section of flow immediately after an expander and apply the heat to the section of flow immediately after a compressor.

Of course unused, as mentioned two paragraphs above, heat can be routed back to the heat source to improve efficiency of the heat source. This might be used in a solar collector. If the heat were transferred by a fluid flowing in the collector, then the hot flow leaving the engine would be introduced at the cooler end of the collector flow. If the heat source were a sunlight concentrator not using fluid flow, then the heat at the engine heat exchanger may be directly applied to the working fluid container and the unused heat would remain in the skin of the container, thus requiring less sunlight to bring the temperature back up to optimum. Very high efficiency could be attained. Note that in the hot end heat exchanger heat exchange is occurring between the hot skin of the engine and the working fluid.

Heat Pump Aspect

It may be easier to understand how the device works as a heat pump, since there is no extremely variable load. Suppose we have a drum or wheel of a compressible fluid rotating. If we now cause fluid to migrate from the center to the periphery of the wheel, as would happen in the compressor fan, this fluid will compress thus raising its temperature. If the fluid is now sent back toward the center of rotation, as would happen in the expander fan, the fluid will expand thus cooling. Thus we have a difference between the temperature at the periphery and the temperature near the center of rotation of a rotor. This temperature difference can be used, assuming heat exchange, as in a heat pump and mechanical energy must be added to continue the rotation. The rotation energy must be added, because the fluid is traveling with higher volume flow at the same distance from the rotation axis in the compressor than in the expander, thus making the energy used in the compressor greater than the energy recovered in the expander. As an aside, the opposite was true of the engine. In a heat pump, heat is added to the working fluid (taking heat out of the surroundings) after expansion but before compression, because that is how a heat pump works at the cool end. Similarly heat is removed from the working fluid to the surroundings at the warm periphery, just before expansion. The addition and removal of heat affects the volume flow not the mass flow. Volume flow affects fluid speed and thus its momentum change and thus pressure on the blades. Of course the cross-section through which the fluid flows could be larger thus creating more force on the blades with the same pressure.

The electric motor in the heat exchanger will be constantly moving very fast. Thus it must be designed to work under those conditions.

### Pressure and Rotation G Force Considerations

The engine or heat pump can be operated with the working fluid held at many atmospheres, usually about 100 atmospheres. It can also be operated at very large rotational G forces. If the compressor is operated near a 7:1 pressure ratio, a large part of that ratio is caused by G forces. Another large part of the pressure ratio is due to the spiral blades pushing the fluid with a radial component. The pushing is caused by inertial effects as the blade tries to increase or decrease the angular momentum of the fluid in the compressor or expander respectively.

In the current invention it is shown to be possible to use two centrifugal compressors of stationary casing design, rather than the rotating drum design as shown in U.S. Pat. No. 7,874,175. They would be connected so the peripheral output of the compressor travels to the peripheral input of the expander through a heat exchanger that is stationary and not rotating with respect to the casings. This is shown in the figures of the current invention.

### BRIEF DESCRIPTION OF THE DRAWINGS

FIG. 1 shows a perspective view of a complete engine, except that the heat exchangers are not shown in detail. The figure shows four centrifugal pumps and the containers of the fluid path connections between them. These paths are only suggestive and paths more like drilled holes and tubes are contemplated. Dynamos 42 and 44 are shown but an electric motor to act as an engine starter is not shown to avoid clutter in the figures and also because the dynamo might be able to be used as a starter.

FIG. 2 shows a cross-section, A-A, going from pump 4 to pump 3. The view includes the hot heat exchanger 7. Both axle 14 and axle 13 rotate clockwise. Fin 24 is attached to a disc attached to axle 14 and similarly for fin 23 and axle 13.

FIG. 3 shows a cross-section, B-B, going from pump 2 to pump 3. The view includes the cold heat exchanger 6. Again, the part containing the external cool flow is not shown as to its entrance and exit.

FIG. 4 is a blow-up of the right end of FIG. 3 including dynamo 42 attached to pump 2 and a small length of cold heat exchanger 6. It shows the magnets and coils and how they are streamlined.

### DETAILED DESCRIPTION OF THE INVENTION

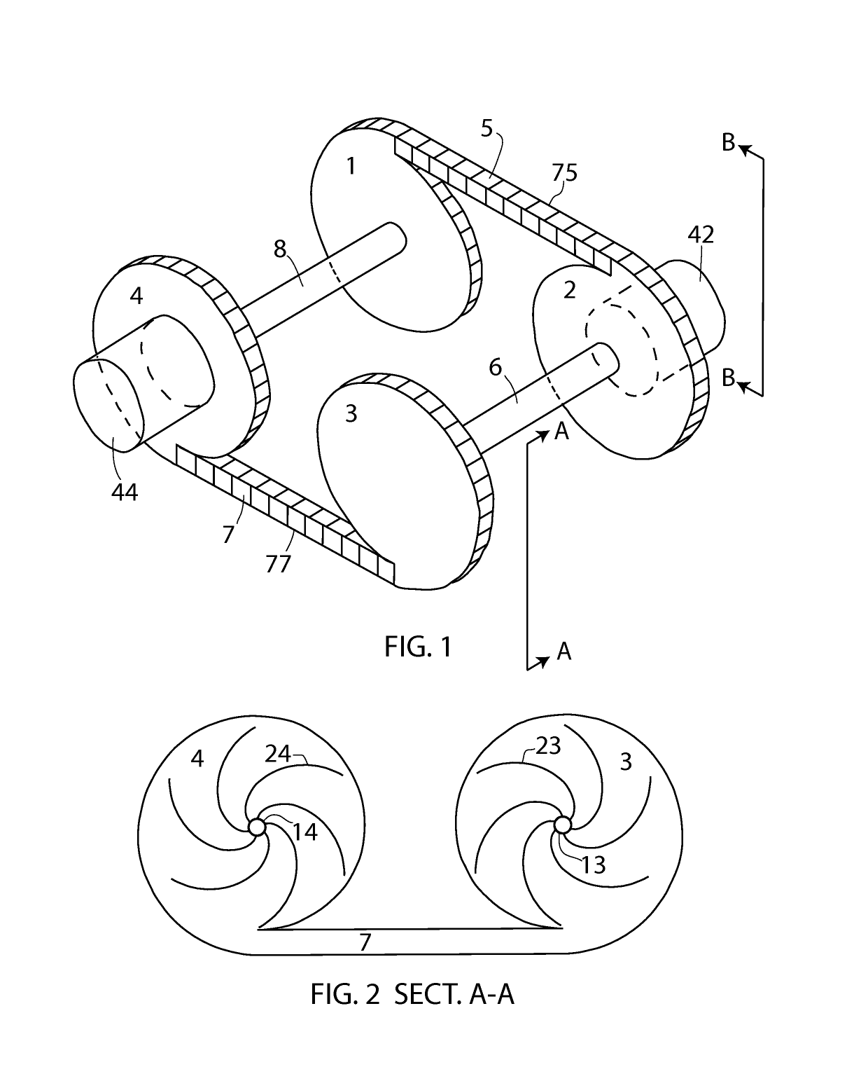

FIG. 1 shows a workable, but simplified, version of the engine. Pump 2 and pump 4 are the two centrifugal pumps which are run in reverse flow to convert input fluid energy to rotation before cooling the fluid by heat exchange in cool fluid conduits 6 and 8 respectively. Centrifugal pumps 1 and 3 are used to increase working fluid pressure before heating the working fluid by heat exchange in hot fluid conduits 5 and 7 respectively. As an aid to understanding for the engine, working fluid flows from pump 1 to pump 2 to pump 3 to pump 4 to pump 1 and repeat.

Notice that the outer parts of the pumps, conduits, and dynamos 42 and 44 and the dynamo wires where they pierce the rest of the container form a substantially stationary fluid container moving very slowly if at all when its motion is compared to the speeds of the working fluid being circulated from pump 1 to pump 2 to pump 3 to pump 4 to pump 1. Also the outer parts can be attached to a vehicle or a floor of a building or wherever the engine will be used, thus moving much slower than the working fluid.

A coil or set of tubes carrying heated fluid can be deployed to enter hot fluid conduit 5 at the end nearest pump 2 and to leave hot fluid conduit 5 at the end nearest pump 1. The entrance and exit of the coil or tubes would be sealed so that working fluid could not escape from hot fluid conduit 5 while traveling from pump 1 to pump 2. The coil or tubes and hot fluid conduit 5 would act as a counter flow heat exchanger to transfer heat from the fluid in the coil or tubes to the working fluid in the hot fluid conduit. A similar coil or tubes could be deployed as a counter flow heat exchanger to enter hot fluid conduit 7 near pump 4 and leave near pump 3. A similar statement can be made about a coil or set of tubes carrying cold fluid entering and leaving conduit 6 or 8 individually, thus providing the cold heat exchangers.

If preferred, the hot fluid conduits 5 and 7 and their associated coils or tubes can be replaced with two sets of tubes, the first set leading from the output of pump 1 to the input of pump 2 at its periphery and the second set leading from the output of pump 3 to the input of pump 4 at its periphery, in which case heat may be applied directly to the tubes and the heat exchange would occur between the outer skin of each tube and the fluid flowing within.

Cold fluid conduit 6 carrying working fluid from centrifugal pump 2 to centrifugal pump 3 also houses the axle that has the rotors for pumps 2 and 3, one at each end. The rotor and axle for pump 3 and also a rotor and axle for pump 4 are shown in the cross-section view labeled A-A in FIG. 1 and shown in FIG. 2. A coil or set of tubes carrying cooling fluid can be deployed to enter cold fluid conduit 6 at the end nearest pump 3 and to leave cold fluid conduit 6 at the end nearest pump 2. The entrance and exit of the coil or tubes would be sealed so that working fluid could not escape from cold fluid conduit 6 while traveling from pump 2 to pump 3. The coil or tubes and cold fluid conduit 6 would act as a counter flow heat exchanger to transfer heat to the fluid in the coil or tubes from the working fluid in the cold fluid conduit. A similar coil or tubes could be deployed, as part of a counter flow heat exchanger, to enter cold fluid conduit 8 near pump 1 and leave near pump 4.

Electricity generator, dynamo 44, is attached to pump 4 and the outer part of the dynamo carrying the magnets rotates with the axle and rotor of the pump. Electricity generator, dynamo 42 is attached to pump 2 and the outer part of the dynamo rotates with the axle and rotor of the pump. The dynamos will be described in much more detail when FIG. 4 is discussed.

Cross-section A-A of FIG. 1 is shown in FIG. 2. It shows more detail including axle 13 attached to the rotor for pump 3, whose blades are numbered 23 and axle 14 attached to the rotor for pump 4, whose blades are numbered 24. The mechanical connections for the rotors and dynamo parts and for the possibly convex discs holding the blades of the rotor may be changed by the engineers. Hot fluid conduit 7 as shown in FIG. 2 was also shown in FIG. 1.

It should be noted that while only one port from each pump is shown leading to conduit 7 there could be multiple ports around each pump leading to conduit 7. More ports on each centrifugal pump would mean less fluid pressure loss on exiting the pump because the fluid would not have to travel so far around the pump on average before exiting. There are many pump designs, and the multiple exits is probably already described somewhere.

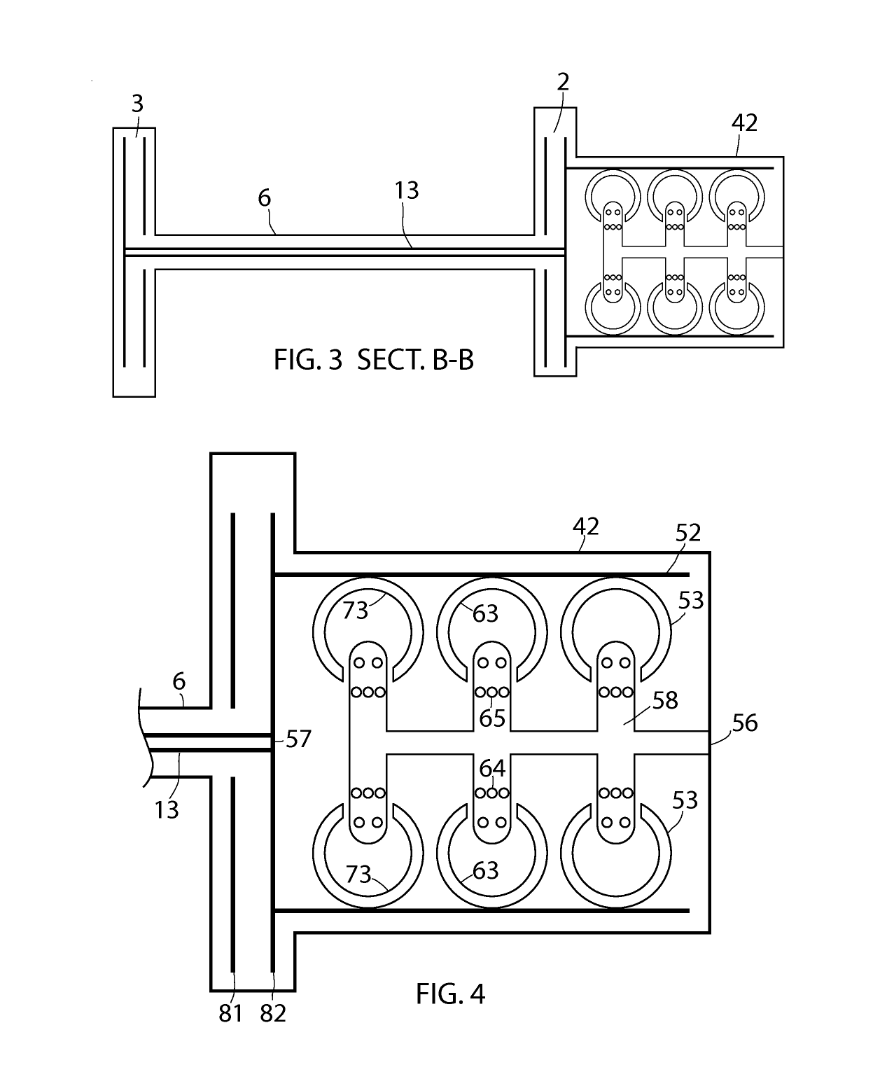

FIG. 3 shows cross-section B-B from FIG. 1. It shows centrifugal pump casings for pump 2 and pump 3. Axle 13 is shown inside cold fluid conduit 6. The axle extends far enough into pump 3 to attach to the outermost convex disc holding the blades 23, of the rotor, shown in FIG. 2. The axle 13 can be extended further through pump 2 to help rotate the magnets of the generator 42, or as in my design the cylindrical magnet holder may be attached to the outermost disc holding the blades of the rotor of pump 2. The blades are not shown in FIG. 3 or 4 because they would appear as straight lines crossing between the discs and be confusing. The discs for pump 2 are shown in FIG. 3 and FIG. 4 but only numbered 81 and 82 at the bottom of FIG. 4.

Generator designs including magnet and wire groupings are too numerous to mention. My preferred version is shown in FIG. 4 and is designed to almost eliminate drag by making both the magnets and the coils aerodynamic. The magnets are moving with the same rotation rate as the rotor blades. The coils while stationary are in a rotating working fluid flow set in rotating motion by the rotating magnets. This flow will be a compromise between the motion of the magnets and the lack of motion of the coils.

FIG. 4 shows a cross-section of pump 2 and dynamo 42 blown up to see more detail. It is a part of cross-section B-B of FIG. 1. Another way to think of it is that it is the right end of FIG. 3 with extra numbering detail.

In FIG. 4, discs 81 and 82 hold the rotor blades of pump 2. Axle 13 causes disc 82 and thus the rest of the rotor to turn. The rotating cylindrical part 52 of the generator dynamo 42 is set in motion by disc 82 to which it is attached. Cylindrical part 52 holds the magnets. The magnets formed as slices of magnet rings 53, 63, and 73, point inward toward the extended axle, instead of pointing away from the axle as in current art. This requires the output wiring 64, and the output wiring 65 shown between the poles of a magnet formed from magnet ring 63 to be nearer the axle and the wires would enter the end of the enclosure close to point 56 where axle 13, if extended, would pierce the enclosure of dynamo 42. The magnets will be sections of a ring of magnetic material 63 which has a volume looking like a horseshoe when cut with two close planes, each plane containing the axle. The whole ring of magnetic material capable of being magnetized would be much like a car tire in shape. Thus it can be cut into many horseshoe-like pieces by planes containing the axle. The poles of the magnets on either end of the horseshoes would alternate north and south poles as you move around the ring of magnetic material, thus neighboring horseshoes are reversed in polarity. The whole would approximate a ring of horseshoe magnets, the ring being centered around the imaginary extended axle of the pump rotor, except that it is also aerodynamic, like a rotating disc would be. This alternating pattern insures that the fields, while being intense near the poles, do not travel far from the magnet array, thus preventing unintended eddy currents in conductors. If the magnets were pointing away from the axle, as in current art, there would be eddy currents in the outer shell of the generator housing.

Discs 81 and 82 should be thermally insulated on their surfaces, except that both surfaces of disc 82 should be insulation free near the axle 13 to allow heat to flow away from the dynamo space containing the magnets. The blades of an expander or compressor can also be thermally insulated.

The voltage output wires connected to the coils would enter the housing in such a way as to prevent working fluid leaks, similar to the entrance of the filament wires in an incandescent bulb. When the ring of magnetic material (which forms a ring of horseshoe magnets) is rotated, the magnets cause a rapidly varying field in the coils of wire, coil 64 and coil 65 being separate examples of coils, connected to electric wires introduced from the end of the generator (dynamo) and placed in an obvious way in the space within the circle of magnets, such that the field lines from each magnet in succession go through one coil. Thus the field is reversed for each new magnet because its polarity is opposite the polarity of the previous magnet. The coils will be encased in a material 58 that is shaped to be aerodynamic, looking much like a discus or round cushion. Each coil wraps itself around an axis substantially parallel to the rotor axis but intersecting the magnetic material 53, 63, and 73. None of that magnetic material is on the rotation axis.

Now that most of the preferred embodiment has been described, there are a few variations among many obvious variations that should be mentioned. First, the hot fluid conduits 5 and 7 can be cut at points 75 and 77 and the points 75 and 77 spliced together to form a single conduit going from pump 3 to pump 2 and another conduit going from pump 1 to pump 4. This would make two separate engines each having only a single compressor and a single expander.

Another obvious possibility is to have more than 4 pumps, for example 8 such that each pump is visited in turn by the working fluid. The eight pumps could be at the vertices of a cube. The four cooling legs containing the axles would be on four parallel edges of the cube, the furthest apart would be in the same flow direction, with nearest edges being in opposite directions. The heating connections would be connecting the vertices in one of the obvious ways.

The cooling heat exchangers can be supplied with an outside flow either in series or in parallel. Similarly, the hot heat exchangers can be visited with external heat supplied in series or in parallel. It might be nice to supply cooling in parallel rather than series to keep the low temperature entering each compressor to a minimum. If tubes are used to introduce external heat, the various hot heat exchangers' tubes could be one above another in a chimney heated by fire. This would allow later heat exchangers to operate at successively lower temperatures. Air would be force fed to the burners and thus force products of combustion through the chimney, since convection would not be sufficient.

One variation for the magnets and coils would be to put the magnets in wheel like structures with the magnets pointing away from the axis of rotor rotation and on axle 13 extended through point 57 of FIG. 4. The stationary coils would then be attached to cylinder 52 which would be disconnected from disc 82 and attached to the stationary end wall containing point 56 of the dynamo.

The configuring or encasing of the ring of magnets in an aerodynamic structure and the encasing of the coils in an aerodynamic ring structure are thought to be new art.

The fact that, in a closed system using a working gas, an expander is on the same rotor axis as a compressor, so that the expander can be rotated by the compressor, transferring torque along the common axle, is thought to be new art.

The fact that all moving parts including expander rotor, axles, and compressor rotor are enclosed within the container for the working fluid is thought to be new art.

The basic design of the engine has unidirectional flow of the working fluid and has the working fluid flow traveling from compressor exit and through a heat exchanger to expander input and from expander output through a heat exchanger to compressor input. Also the temperature change within the pumps is greater than the temperature change in the heat exchangers, thus making unnecessary a regenerator or an extra heat exchanger between the basic heat exchangers. The basic design of this paragraph has been disclosed and claimed in patent application Ser. No. 12,291,148, now U.S. Pat. No. 8,087,247. The only preferred design previously disclosed shows the whole of each centrifugal pump including casing rotating. As a matter of fact, almost the whole engine including the heat exchangers was rotating. The new design shown in the current patent shows only the axle and rotor of each pump rotating, while the pump casing and heat exchangers remain stationary. This rotors on an axle internal to the engine, in conjunction with the above engine properties, might be considered new art.

As in the prior patent, the working fluid should be a monatomic gas almost as heavy as air and at about 50 atmospheres when the engine is resting. A diatomic gas takes twice the pressure ratio in an adiabatic compression to get the same temperature ratio as a monatomic gas. Argon is cheap being a by-product of oxygen production and about 1% of the atmosphere; whereas, oxygen is 20% of the atmosphere. The argon can be mixed with some helium to increase thermal conductivity. Krypton is twice as heavy as argon and still not too expensive. It would be used in applications like solar power, where engine efficiency is critical and would be preferred to be far above 50% efficiency, thus requiring less mirrors to get the same output power. I am trying to stay away from using specific numbers, but some of the numbers, and where on the internet they can be found, are available in remarks to the examiner from the above patent application.

21. A device comprising
a working fluid contained within
a substantially stationary fluid container being part of said device,
a first compressor of at least one compressors,
a first expander of at least one expanders to produce power from the flow of said working fluid,
a unidirectional flow traveling within said container all the way from said first compressor to said first expander and eventually back to said first compressor, said unidirectional flow being continuous at most, if not all, reference points, during several cycles of device operation when the device is operating substantially at constant speed in the preferred operating range of speed, said reference points being stationary with respect to the device, said unidirectional flow traveling in
a first fluid connection, comprising at least one tube, to carry a first segment of said unidirectional flow, which connection communicates between at least one output of said first compressor and at least one input of said first expander,
a second segment of said unidirectional flow traveling within said container all the way from an expander of said at least one expanders to said first compressor, said second segment of said unidirectional flow being continuous at most, if not all, reference points, during several cycles of device operation when the device is operating substantially at constant speed in the preferred operating range of speed, said reference points being stationary with respect to the device, said second unidirectional flow traveling in
a second fluid connection, comprising at least one tube, to carry said second segment of said unidirectional flow, which connection communicates between the output of said an expander and the input of said first compressor, said working fluid being thus free to travel from said an expander to said first compressor and then from said first compressor to said first expander without being able to leave the said container,
said segments of unidirectional flow being operative substantially all of the time during long operational periods each period being sufficient to circulate the same atoms of working fluid to pass through said first fluid connection many times,
a means located along said first fluid connection to exchange heat in a first direction of heat flow between said working fluid and some system outside of said working fluid while said working fluid is flowing in said first fluid connection,
a means located along said second fluid connection to exchange heat in the opposite direction to said first direction of heat flow between said working fluid and some system outside of said working fluid while said working fluid is flowing in said second fluid connection,
said working fluid being contained in said fluid container the whole of which is substantially stationary, so that, except for minor leaks, if any, none of the fluid escapes from the substantially stationary fluid container during device running times,
said container being constructed such that any rapidly moving parts of said at least one expanders and of said at least one compressors and all rapidly moving parts mechanically attached to those moving parts are fully surrounded by said substantially stationary fluid container,
said fluid container, the whole of which is substantially stationary, moving very slowly if at all when its motion is compared to the maximum speeds of the working fluid.

22. The device of claim 21 wherein said second fluid connection contains an axle, which is totally contained within said fluid container, said axle going from a rotor in said an expander to a rotor in said first compressor, so that the rotor in said first compressor can be rotated by the rotor in said an expander, transferring torque along the common axle.

23. The device of claim 21 wherein the said means located along said first fluid connection to exchange heat in a said first direction of heat flow is substantially stationary when compared with the motion of the rapidly moving parts of said first expander and of said first compressor and wherein said means located along said second fluid connection to exchange heat in the opposite direction to said first direction of heat flow is also substantially stationary.

24. The device of claim 21 further containing a means, for example wires extending through the wall of the container, to transmit electric power from a dynamo inside said substantially stationary fluid container to wires outside of said substantially stationary fluid container part of said means forming part of said substantially stationary fluid container.

25. The device of claim 21 wherein the said device has a dynamo which has magnets which are part of an assembly rotated by a means using the rotation of at least one of said rapidly moving parts of said first expander and of said first compressor and wherein the wire coils are stationary with respect to said substantially stationary fluid container of said working fluid, wires from said coils both piercing and being part of said container to allow electricity from the dynamo to enter the world outside the container,
the magnets plus their encasing material if any being of circular symmetry around the axle, thus having a contour that will not add to motion of the surrounding gas as it rotates, in other words the magnet assembly showing the same configuration at all angles of rotation.

26. A device comprising
a working fluid contained within
a substantially stationary fluid container being part of said device,
a first compressor of at least one compressors,
a first expander of at least one expanders to produce power from the flow of said working fluid,
a unidirectional flow traveling within said container all the way from said first compressor to said first expander and eventually back to said first compressor, said unidirectional flow being continuous at most, if not all, reference points, during several cycles of device operation when the device is operating substantially at constant speed in the preferred operating range of speed, said reference points being stationary with respect to the device, said unidirectional flow traveling in
a first fluid connection, comprising at least one tube, to carry a first segment of said unidirectional flow, which connection communicates between at least one output of said first compressor and at least one input of said first expander,
a second segment of said unidirectional flow traveling within said container all the way from an expander of said at least one expanders to said first compressor, said second segment of said unidirectional flow being continuous at most, if not all, reference points, during several cycles of device operation when the device is operating substantially at constant speed in the preferred operating range of speed, said reference points being stationary with respect to the device, said second segment of said unidirectional flow traveling in
a second fluid connection, comprising at least one tube, to carry said second segment of said unidirectional flow, which connection communicates between at least one output of said an expander and at least one input of said first compressor, said working fluid being thus free to travel from said an expander to said first compressor and then from said first compressor to said first expander without being able to leave the said container,
said segments of unidirectional flow being operative substantially all of the time during long operational periods each period being sufficient to circulate the same atoms of working fluid to pass through said first fluid connection many times,
a means located along said first fluid connection to exchange heat in a first direction of heat flow between said working fluid and some system outside of said working fluid while said working fluid is flowing in said first fluid connection,
a means located along said second fluid connection to exchange heat in the opposite direction to said first direction of heat flow between said working fluid and some system outside of said working fluid while said working fluid is flowing in said second fluid connection,
said working fluid being contained in said device in said substantially stationary fluid container, so that, except for minor leaks, if any, none of the fluid escapes from the substantially stationary fluid container during device running times,
said substantially stationary fluid container moving very slowly if at all when its motion is compared to the maximum speeds of the working fluid,
the rapidly moving parts of said first expander and of said first compressor and all rapidly moving parts mechanically attached to those moving parts being fully surrounded by said substantially stationary fluid container,
said device further containing a means to transmit electric power from a dynamo inside said substantially stationary fluid container to wires outside of said substantially stationary fluid container part of said means forming part of said substantially stationary fluid container.

27. The device of claim 26 wherein said dynamo contains magnets which are on an assembly rotated by a means using the rotation of at least one rotating part of said device the rotating part being contained within said substantially stationary fluid container and the wire coils of which dynamo are stationary with respect to said substantially stationary fluid container, the coils and magnets being contained within said substantially stationary fluid container, the wires from said coils being part of and piercing the rest of said container, the wires thus being part of said container at the place of piercing, to allow electricity from the dynamo to enter the world outside the container.

28. The device of claim 26 wherein the coils of said dynamo are in at least one aerodynamic structure, which has a surface with circular symmetry, thus allowing the coils and structure to rotate without disturbing the surrounding fluid, except by friction between the structure surface and the fluid.

29. The device of claim 26 wherein said second fluid connection contains an axle going from said rotor in said an expander to a rotor in said first compressor, so that the rotor of said first compressor can be rotated by the rotor in said an expander, transferring torque along the common axle which axle is fully contained in said substantially stationary fluid container.

30. The device of claim 26 wherein the said means located along said first fluid connection to exchange heat in a first direction of heat flow is substantially stationary unlike the motion of the rotors and said means located along said second fluid connection to exchange heat in the opposite direction to said first direction is substantially stationary unlike the motion of the rotors.

31. A device for converting between heat energy and mechanical energy comprising
a working fluid, contained within
a substantially stationary fluid container being part of said device,
at least one compressor,
at least one expander,
at least one heat exchanger of a set one to exchange heat in one direction of heat flow between said working fluid and a system outside said working fluid,
at least one heat exchanger of a set two to exchange heat in the opposite direction of heat flow from said one direction of heat flow between said working fluid and a system outside said working fluid,
said device being put together so that during device operation in its preferred operating range said working fluid flows through said at least one expander, then along a flow path that passes through a heat exchanger of set one, then through said at least one compressor, then along a flow path that passes through a heat exchanger of set two,
said working fluid flowing in a unidirectional, continuous flow at most points within the flow outside the expanders and compressors, during several cycles of device operation when the device is operating substantially at constant speed in the preferred operating range of speed, said points in the flow being stationary with respect to said substantially stationary fluid container,
said fluid being contained in said device, so that, except for minor leaks, none of the working fluid escapes from the device during operation,
all rapidly moving parts of said at least one expander and of said at least one compressor and all rapidly moving parts mechanically attached to those moving parts being fully surrounded by said substantially stationary fluid container during device operation,
said at least one heat exchanger of a set one to exchange heat in one direction of heat flow being substantially stationary when its speed, if any, is compared with the maximum speed of said rapidly moving parts,
said at least one heat exchanger of a set two to exchange heat in the opposite direction of heat flow being substantially stationary when its speed, if any, is compared with the maximum speed of said rapidly moving parts.

32. The device of claim 31 wherein there is an axle going from a rotor in said at least one expander to a rotor in said at least one compressor, so that the rotor of said at least one compressor can be rotated by the rotor in said at least one expander, transferring torque along the common axle.

33. The device of claim 31 further containing a means to transmit electric power from a dynamo inside said substantially stationary fluid container to wires outside of said substantially stationary fluid container at least part of said means forming part of said substantially stationary fluid container.

34. The device of claim 33 wherein the magnets of said dynamo are in at least one aerodynamic structure which has a surface with circular symmetry, thus allowing the magnets and structure to rotate without disturbing the surrounding fluid, except by friction between the structure surface and the fluid.

35. The device of claim 33 wherein the coils of said dynamo are in at least one aerodynamic structure which has a surface with circular symmetry, thus allowing the coils and structure to rotate without disturbing the surrounding fluid, except by friction between the structure surface and the fluid.
